(19) United States
(12) Patent Application Publication
(10) Pub. No.: US 2025/0327784 A1
(43) Pub. Date: Oct. 23, 2025

(54) METHOD AND DEVICE FOR LIQUID DELIVERY TO THE ADSORBENT LAYER

(71) Applicants: Aneta HALKA-GRYSINSKA, Lublin (PL); Anna KLIMEK-TUREK, Lublin (PL); Radoslaw L. GWARDA, Siennica Nadolna (PL); Tadeusz H. Dzido, Lublin (PL)

(72) Inventors: Aneta HALKA-GRYSINSKA, Lublin (PL); Anna KLIMEK-TUREK, Lublin (PL); Radoslaw L. GWARDA, Siennica Nadolna (PL); Tadeusz H. Dzido, Lublin (PL)

(21) Appl. No.: 19/211,131

(22) Filed: May 16, 2025

Related U.S. Application Data
(63) Continuation of application No. 17/863,217, filed on Jul. 12, 2022, now abandoned.
Application No. 17/863,217 is a continuation-in-part of application No. 16/611,240, filed on Nov. 6, 2019, now abandoned.

(30) Foreign Application Priority Data
May 9, 2017 (PL) PL421538A

(51) Int. Cl. G01N 30/93

(52) U.S. Cl. CPC G01N 30/93

(57) ABSTRACT

To develop the chromatogram, a prepared plate is placed in a chromatographic chamber where a tip, connected to multiple supply lines for different eluent components, enters from below. Each line includes a reservoir, pump, and tubing system. The tip is moved along a set path by a three-dimensional machine while the eluents are pumped with varying flow rates, controlled by a computer to produce a changing eluent composition over time. A digital camera tracks the position of the eluent front, and this data is used by the computer to adjust pump operations in real-time. Once the eluent front reaches its final position, pumping stops. The plate is then removed and dried, resulting in a developed chromatogram.

### CROSS-REFERENCE DATA

This US Patent Application is a continuing application of a co-pending U.S. patent application Ser. No. 17/863,217 filed on 12 Jul. 2022 entitled “METHODS FOR PERFORMING A THIN LAYER CHROMATOGRAPHY”, which, in turn, is a continuation-in-part of the co-pending U.S. patent application Ser. No. 16/611,240 filed on 8 May 2018 entitled “The method of liquid delivery to the adsorbent layer”, which, in turn, claims a priority date benefit via the International Patent Application No. PCT/PL2018/000046 with the same title to the Polish Patent Application No. PL421538A filed 9 May 2017. This patent application is also a US filing under the Patent Prosecution Highway program of the European Patent Application No. 18798331.7, now European Patent No. EP3635386B1 entitled METHOD AND DEVICE FOR LIQUID DELIVERY TO AN ADSORBENT LAYER, which is a national phase entry of the above-cited PCT Application No. PCT/PL2018/000046, all of which are incorporated herewith in their respective entireties by reference.

### BACKGROUND

The subject of the invention is a method of liquid delivery, particularly the eluent to the adsorbent layer of the chromatographic plate, enabling the development of thin-layer chromatograms with the preservation of fixed qualitative and quantitative composition of the eluent or/and with a shift of its qualitative and quantitative composition during the process of analytical and preparative separation as well as during the preparation of sample solutions for qualitative and quantitative analysis with the use of instrumental techniques.

In the current state of the art, the development of isocratic thin-layer chromatograms, that is with the preservation of fixed qualitative and quantitative composition of the eluent, is performed through the simple contact of the eluent solution, located at the bottom of a jar or in a special reservoir, with the adsorbent layer of the chromatographic plate. The process of chromatogram development is led in conventional or horizontal chambers. In the case of the former these are usually glass containers, cuboidal or cylindrical, where the appropriate portion of eluent solution is poured at its bottom. Then the chromatographic plate, with substance solutes applied to the start line, is submerged to small depth in the eluent. Then the eluent is absorbed with capillary forces into the adsorbent layer and the chromatogram development occurs automatically. It is stopped, when the eluent front reaches the opposite border of the chromatographic plate or earlier. This method of eluent delivery to the adsorbent layer of the chromatographic plate, as well as the method of chromatogram development, is the oldest and still often used in the laboratory practice, and is reported in the literature, i.e.: 1. J. Gasparic, J. Huracek. Laboratory handbook of paper and thin-layer chromatography, Ellis Horwood, Ltd., Chichester 1978. 2. F. Geiss, Fundamentals of thin-layer chromatography (Planar chromatography), Huthig, Heidelberg, 1987. In the case of the second type of chambers, the chromatographic plate is placed in a horizontal position in the chamber and the eluent reservoir is situated approximately at the same height. The initiation of chromatogram development, that is eluent delivery to the chromatographic plate, takes place after contacting the eluent solution with the adsorbent layer. The interruption of the chromatogram development is performed by pulling the chromatographic plate out of the chamber or moving this plate away from the eluent reservoir, when the eluent front reaches the desired migration distance, usually the middle or end of the plate. This development method is known, among others, from patent descriptions: no. PL 161388 BI, T. Dzido, Sposob i komora do rozwijania chromatogramow cienkowarstwowych (Eng. The mode and the chamber for development of thin-layer chromatograms), and no. PL 165042 BI, T. Dzido, E. Soczewinski, Sposob i komora do jednoczesnego rozwijania dwoch chromatogramow cienkowarstwowych (Eng. The mode and the chamber for simultaneous development of two thin-layer chromatograms).

The above chromatogram development methods, in the conventional or horizontal chambers, are used to separate mixtures of substances, as well as to prepare samples for instrumental analysis. The former application is described in literature items: 1. C. Oellig, W. Schwack, Planar solid phase extraction—A new clean-up concept in multi-residue analysis of pesticides by liquid chromatography-mass spectrometry, Journal of Chromatography A, 1218 (2011) 6540-6547; 2. Frontally eluted components procedure with thin layer chromatography as a mode of sample preparation for high performance liquid chromatography quantitation of acetaminophen in biological matrix. A. Klimek-Turek, M. Sikora, M. Rybicki, T. Dzido. J. Chromatogr. A 1436 (2016) 19-27.

The development of gradient chromatograms, that is with a change of qualitative and quantitative composition of the eluent, in both types of chambers described above, can be carried out by changing the mobile phase solution during the development process. However, this development is troublesome because it requires constant supervision of the operator. Moreover, the development of chromatograms in conventional chambers is not economical due to large solvent consumption. The method of gradient chromatogram development is known, among others, from publications: 1. E. Soczewinski, L. K. Czapinska, Stepwise gradient development in sandwich tanks for quasi-column thin-layer chromatography. J. Chromatogr. 168 (1979) 230; 2. G. Matysik, W. Markowski, E. Soczewinski, B. Polak, Computer aided optimization of stepwise gradient profiles in thin-layer chromatography. Chromatographia 34 (1992) 303; and 3. W. Golkiewicz, Gradient development in thin-layer chromatography, in Handbook of Thin-Layer chromatography, J. Sherma, B. Fried (eds.) Marcel Dekker, Inc., New York, Basel, 2003.

The other method known for supplying the eluent to a chromatography plate is one in which the adsorbent layer is indirectly contacted with the eluent contained in the reservoir. In this process, the eluent is supplied to the adsorbent layer by means of a wick of blotting paper. One end of the paper wick is immersed in the eluent, in the reservoir, and the other end touches the adsorbent layer. This combination allows for the eluent solution to be transported through the paper strip to the chromatographic plate adsorbent layer and is described in M. Brenner, A. Niederwieser, Overrun thin layer chromatography. Experientia 17 (1961) 237-238. This way the isocratic development of chromatograms is usually carried out, however, it is not used for gradient development. The consumption of solvents is small, much smaller than during the conventional development of chromatograms.

Another method uses a porous block to transport the eluent from the reservoir to the adsorbent layer. In this method, the porous block is partially immersed in the eluent solution and the upper part touches the adsorbent layer of the chromatographic plate located horizontally. Capillary forces generated in the porous block are used to transport the eluent solution from the reservoir to the adsorbent layer. This method is described in the literature: L. Kraus, Concise practical book of thin-layer chromatography, Desaga, Heidelberg, 1993. This method is also practically used only for the isocratic development of chromatograms. Its advantage is the relatively low consumption of solvents.

It should be noted that all of the above-mentioned methods can be used for the multiple chromatogram development, which consists of successive multiple developments and evaporations of the eluent. In the subsequent stages of such development, an eluent with an altered quantitative and/or qualitative composition can be used. That is why the multiple chromatogram development can be classified as a gradient development. Various variants of this method are described in a more detail in B. Szabady, The Different Models of Development, in Planar chromatography in A retrospective view for the third millennium, Sz. Nyiredy (ed.), Springer, Budapest, 2001. A disadvantage of this method of development is the long time of the separation process and the high consumption of solvents.

The essence of the method of delivering the liquid to the adsorbent layer, in which the liquid stream is directed to the outer surface of the adsorbent layer, is that the liquid stream is moved over the outer surface of the adsorbent layer along the set path. The path preferably has any shape, and in particular it has the shape of a straight line, a broken line and/or a closed line. The path can also consist of many separate lines. The liquid stands for the eluent component, the eluent or the solution of the substances to be separated.

The liquid stream is moved along the preset path, preferably from the first turning point to the second toiling point and back again, and the travel speed from the first turning point to the second turning point may differ from the travel speed from the second turning point to the first turning point, especially the travel speed from the first turning point to the second toning point may be lesser than the travel speed from the second turning point to the first turning point.

The first turning point and the second turning point can be arbitrarily located relative to the adsorbent layer, that is they can lie below or above the adsorbent layer, and they can also lie outside the outline of the adsorbent layer.

The liquid stream is moved preferably in one direction, at a constant speed, and especially along the path in the shape of a closed line. The liquid stream can also be moved sequentially over the surfaces of at least two separate adsorbent layers.

The delivery efficiency of the eluent or its constituents varies over time, and in particular the efficiency of the eluent is equal to or lower than the ability of the eluent to absorb the eluent by the adsorbent layer. In a particular case, the eluent efficiency is greater than the absorption rate of the eluent by the adsorbent layer. In this situation, the excess liquid is preferably removed by gravity and collected in a gutter, and then if need be the solid contaminants may be separated and the missing components refilled, and then re-supplied to the adsorbent layer.

The quantitative and qualitative composition of the eluent preferably changes over time. That is why the individual components of the eluent are separately pumped, after which they are combined directly before or on the outer surface of the adsorbent layer, and in particular each component of the eluent is pumped with a separate tube. In this situation, in order to better mix the components, the eluent stream is stimulated to transverse vibrations.

In another variant, each component of the eluent is pumped with a separate flexible tube to a collector in which they are joined, after which the obtained eluent solution is delivered through a common rigid tube onto the outer surface of the adsorbent layer.

The aggregated stream preferably consists of several individual streams combined together in a collector or in a nozzle connecting multiple rigid tubing.

In a special case, the rigid tube has a form of an opening in the collector wall. The liquid stream axis is preferably perpendicular to the outer surface of the adsorbent layer, and when the eluent is pumped with an efficiency greater than its absorption rate by the adsorbent layer, the stream axis intersects the outer surface of the adsorbent layer at sharp angle.

Depending on the purpose of the liquid delivery, the liquid stream may be located below or above the adsorbent layer.

During the delivery of the eluent solution to the adsorbent layer, the progress of the eluent front migration is observed in the adsorbent layer and the amount of the eluent or/and its components are pumped accordingly.

The components of the eluent are preferably pumped in a form of separate streams, which, depending on the needs, are specific solvents, their solutions and/or solutions of substances in solvents.

The proposed solution contributes to the maximum savings of solvents composing the eluent. Due to the different and controlled speed of supply of the eluent components directly on the adsorbent layer, the method allows for gradient development of the chromatograms while minimizing the gradient delay associated with the mixing of these components. This feature allows to perform the gradient chromatogram development process accurately and precisely. The method also allows for controlled delivery of the eluent to the adsorbent layer, particularly at a lower efficiency than that resulting from the rate of absorption of the eluent through the adsorbent layer as a result of capillary action. This last feature of the method contributes to eliminating the excess flow of the eluent onto the surface of the adsorbent layer during the development of the reverse-phase chromatograms. Moreover, the method in question can be used much more easily for the automatic chromatogram development for analytical and preparative separation and for the preparation of samples for analysis with instrumental techniques compared to methods known from the current state of art. Particularly the utilization of the proposed method for the preparation of samples for chemical analysis with instrumental techniques may be beneficial due to the possibility of supplying the eluent to any place of the adsorbent layer, which contributes to facilitating the separation of target chemical substances from other components of the matrix and/or concentration/focusing of the target compounds in a form of the smallest possible zone in a specific location of the adsorbent layer. A very important feature of the proposed method is the minimal consumption of the eluent because it is equal or slightly greater than the volume absorbed by the adsorbent layer. Therefore, the consumption of solvents during the development of chromatograms with the proposed method is comparable to their consumption in horizontal chambers, and is at least several times smaller than the development of chromatograms in conventional chambers.

### BRIEF DESCRIPTION OF THE DRAWINGS

The method of liquid delivery to the adsorbent layer is presented in the example implementations on a schematic drawing in which:

FIG. 1 shows the schematic diagram of the eluent delivery system;

FIG. 2 shows the enlarged detail “A” from FIG. 1;

FIG. 3 shows the view Wi from the direction indicated in FIG. 2;

FIG. 4 shows the enlarged detail “A” from FIG. 1;

FIG. 5 shows the view W₂ from the direction indicated in FIG. 4;

FIG. 6 shows the chromatogram image obtained in Example I;

FIG. 7 is the schematic diagram of the first, alternative system for the eluent delivery;

FIG. 8 shows the chromatogram image obtained in Example II;

FIG. 9 shows the schematic diagram of the second, alternative system for the eluent delivery;

FIG. 10 shows the plan view of the inside of the chamber of the second alternative system from the direction W₃ indicated in FIG. 9;

FIG. 11 shows the view of the plate with applied internal standard solutions and test solutions in order to conduct the instrumental analysis according to Example III;

FIG. 12 shows the two stages of the chromatogram development on the plate shown in FIG. 11;

FIG. 13 shows the view of the plate shown in FIG. 11 after concentration of the spots;

FIG. 14 shows the view of the plate prepared for the instrumental analysis according to Example IV;

FIG. 15 shows the view of the plate shown in FIG. 14 after the chromatogram has been developed;

FIG. 16 shows the view of the plate shown in FIG. 14 after the initial concentration;

FIG. 17 shows the view of the plate prior to final concentration;

FIG. 18 shows the view of the plate prepared for the chromatogram development according to Example V;

FIG. 19 shows the view of the plate with the developed chromatogram.

### DETAILED DESCRIPTION OF THE INVENTION

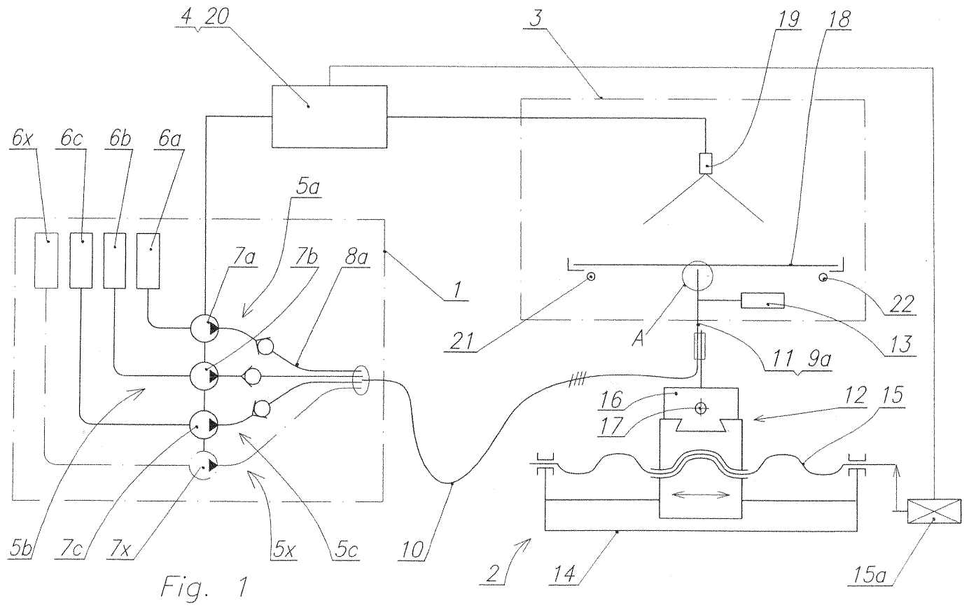

FIG. 1 shows the schematic diagram of a basic system for delivering the eluent to the adsorbent layer. The system consists of a hydraulic unit (1), a three-dimensional machine (2), a chromatographic chamber (3) and a control unit (4).

The hydraulic unit consists of a series of identical supply lines (5a, 5b, 5c . . . 5x). The first supply line (5a) consists of the first reservoir (6a) connected to the first pump (7a), which has the outlet to which the first flexible tube (8a) is connected and then terminated with the first rigid tube (9a). All the flexible tubes (8a, 8b, 8c . . . 8x) along with the rigid tubes (9a, 9b, 9c . . . 9x) are connected into a bundle (10) at a certain part of the length. The tip (11) of the bundle (10) is attached to the support (12) of the three-dimensional machine (2). The reservoirs (6a, 6b, 6c . . . 6x) are intended for the eluent or its separate components, which, depending on the needs, are specific solvents, their solutions and/or solutions of substances in the solvents. The tip (11) adheres to the working segment of the vibrator (13), which, if necessary, stimulates it to vibrate for better mixing of solutions pumped through rigid tubes (9a, 9b, 9c . . . 9x), while the vibration amplitude does not exceed several internal diameters of the rigid tube (9a).

The three-dimensional machine (2) consists of a base (14) to which the first lead screw (15) is mounted together with the support (12) with a transverse carriage (16) driven by the second lead screw (17). The first lead screw (15) is driven by the first electric motor (15a) and the second lead screw (17) is driven by the second electric motor not shown in the drawing. The three-dimensional machine (2) allows the tip (11) of the bundle (10) to travel along the two mutually perpendicular directions, under almost the entire surface of the chromatographic plate (18), hereinafter referred to as the “plate” (18).

Inside the chromatographic chamber (3), there is a plate (18), in a horizontal position, directed with the adsorbent layer downwards, while over the plate (18) there is a camera (19) mounted to observe the progress of the eluent front. The camera (19) is connected to a computer (20), which simultaneously controls the operation of the pumps (7a, 7b, 7c . . . 7x) and the three-dimensional machine (2), and the position of the tip (11) relative to the entire surface of the plate (18), starting from the first turning point (21) to the second turning point (22) along the path lying in the plane of the drawing.

The control unit (4) consists of a computer (20) in combination with a camera (19) and electric executive elements, including circuit switchers incorporated in the electric supply circuits of the pumps (7a, 7b, 7c . . . 7x) and electric motors (15a) driving the lead screws (15, 17).

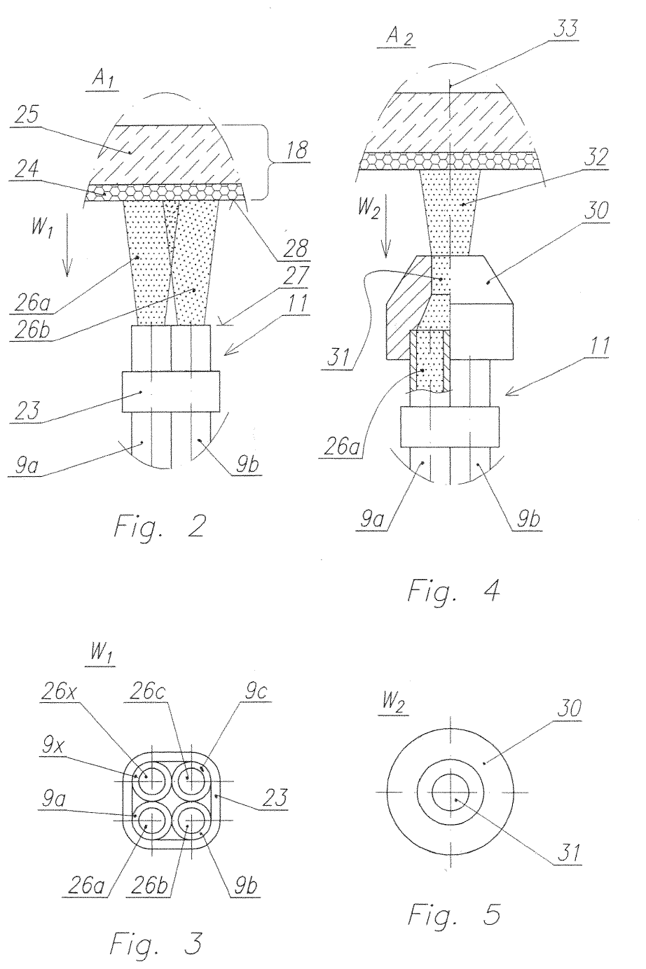

FIG. 2 shows the enlarged detail “A” comprising the tip (11) and the plate (18), and FIG. 3 shows the top view of the tip (11) from the side of the plate (18). The tip (11) consists of four rigid tubes adjacent to each other (9a, 9b, 9c . . . 9x) and connected by a band (23). The plate (18) in turn consists of an adsorbent layer (24) adhering to the carrier plate (25) made of a transparent material. From each of the rigid tubes (9a, 9b, 9c . . . 9x) single streams (26a, 26b, 26c . . . 26x) flow out, which combine and thereby mix between the tip (27) of the tip (11) and the outer surface (28) of the adsorbent layer (24) and then also on it.

FIG. 4 shows the enlarged detail “A” showing how the tip (11) could be built. The tip (11) is equipped with a nozzle (30) inside which the single streams (26a, 26b, 26c . . . 26x) join and the combined stream (32) flows out through the exit hole (31), the axis (33) of which is perpendicular to the outer surface (28) of the adsorbent layer (24).

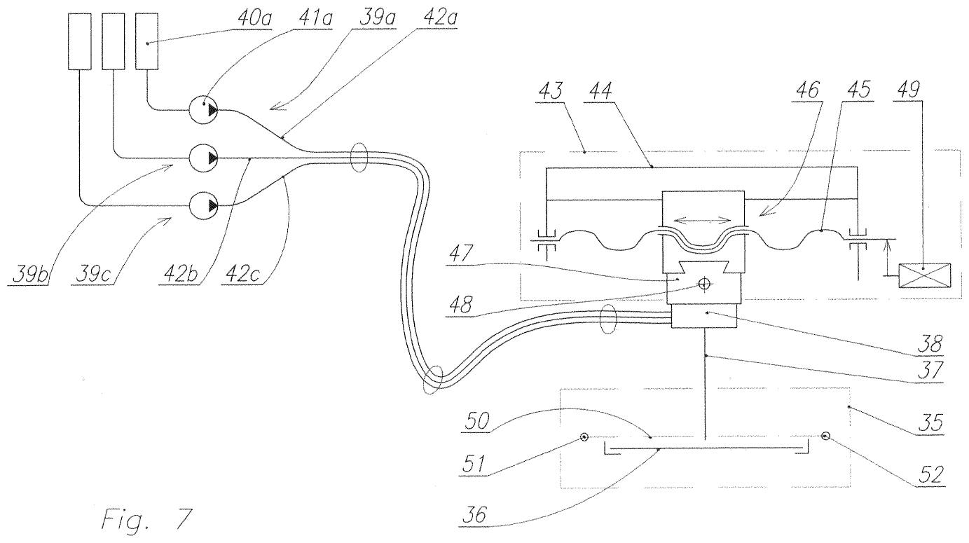

FIG. 5 shows the nozzle (30) from a top view. The nozzle (30) is in the form of a rotatable solid, and its axis (33) has the exit hole (31).

### Example I

The arrangement shown in FIGS. 1, 3 and 4 was used to supply the eluent according to the method of the invention in order to separate the mixture by gradient elution, using only the first two supply lines (5a, 5b). The first supply line (5a) delivers the first solution, which is a solution of 100 mM trifluoroacetic acid in methanol. The second supply line (5b) provides the second solution, which is a solution of 100 mM trifluoroacetic acid in water. As a plate (18), a 10×20 cm HPTLC RP-18W chromatographic plate from Merck was used, on which 2 μL, volume portions of test dye mixture were applied in eighteen places to the start line, parallel to the long edge of the plate (18). The portions of the test mixture were applied using the Camag's Linomat V semi-automatic sample applicator. The space between the cylinder and the piston of the 20 mL syringe was used as the reservoir, and the syringe pump was used as a pump. As a three-dimensional machine (2), the drive mechanism of a three-dimensional printer was used. Flexible tubes (8a, 8b, 8c . . . 8x) were made of Teflon with internal diameter of 0.2 mm and external diameter of 1.6 mm, while rigid tubes (9a, 9b, 9c . . . 9x) were made of stainless steel tubes with an internal diameter 0.2 mm and external 0.8 mm. The distance of the nozzle (30) from the surface of the adsorbent layer was set to 0.1 mm, with the exit hole diameter being 0.5 mm, and the movement speed from the first taming point (21) to the second taming point (22) was 30 mm/s and the return speed was 100 mm/s.

In order to develop the chromatogram, the previously prepared plate (18) is placed in the chromatographic chamber (3), to which the tip (11) enters from below. The first solution is then pumped until the first flexible tube (8a) and the rigid tube (9a) are filled and the second solution is pumped until the second flexible tube (8b) and the second rigid tube (9b) are filled. The total pumping yield of both solutions was set before the experiment and was between 2 and 5 mL/h, that is below the absorption rate of the eluent by the adsorbent, wherein with the first pump (7a) delivers the first solution with a yield of 1.6 to 3.0 mL/h and the second pump (7b) pumps the second solution in a flow rate of 0.2 to 3.0 mL/h.

The tip (11) terminated with the nozzle (30) is then set at the first taming point (21), and then by means of the three-dimensional machine (2) it is moved to the second taming point (22) and back, while simultaneously both solutions are pumped with variable efficiency controlled by computer (20). The pumping efficiency of both solutions was programmed to obtain the following percentage concentrations of both solutions, depending on the distance traveled by the eluent front:
1) 40% of the first solution plus the second solution of ad 100, the distance traveled by the front of the eluent from 0 (starting line) to 10 mm, the efficiency of the eluent delivery 5 mL/h,
2) 60% of the first solution plus the second solution of ad 100, the distance traveled by the front of the eluent from 10 mm to 20 mm, the efficiency of the eluent delivery 5 mL/h, 3) 70% of the first solution plus the second solution of ad 100, the distance traveled by the front of the eluent from 20 mm to 40 mm, the efficiency of the eluent delivery 3 mL/h,
3) 80% of the first solution plus the second solution of ad 100, the distance traveled by the front of the eluent from 40 mm to 70 mm, the efficiency of the eluent delivery 2 mL/h,
4) 90% of the first solution plus the second solution of ad 100, the distance traveled by the front of the eluent from 70 mm to 80 mm, the efficiency of the eluent delivery 2 mL/h.

Both solutions are premixed in the nozzle (30) and further on the outer surface (28) of the adsorbent layer (24). This is when the adsorbent layer (24) is wetted with the eluent solution, which leads to the development of the chromatogram. At the same time, the digital camera (19) registers the position of the moving eluent front visible through the carrier plate (25) and the signals on the migration distance of the eluent front are collected via the computer (20) and the pumps (7a) and (7b) respectively are controlled based on this information that deliver the eluent components, with a programmed ratio, to the adsorbent layer.

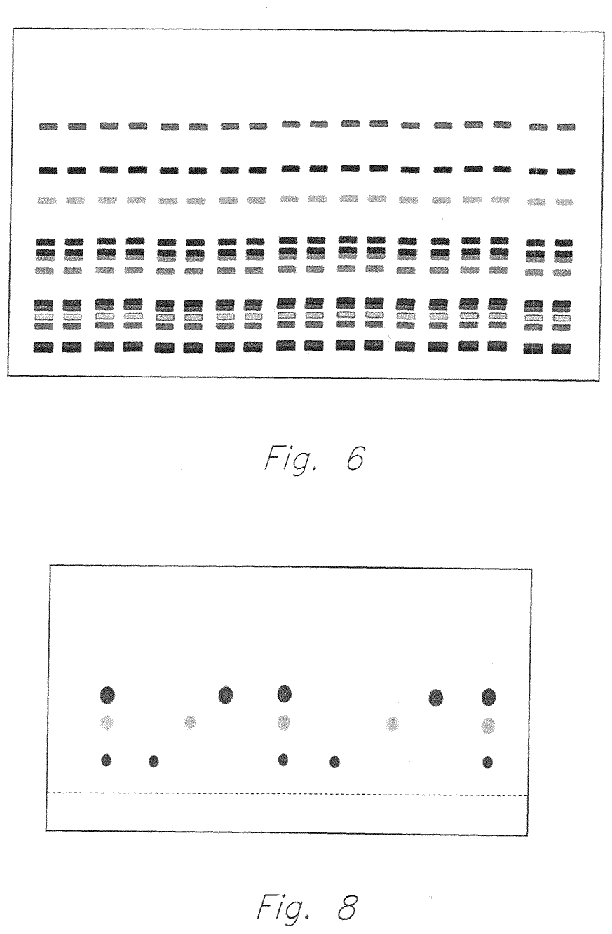

After reaching the final migration distance of the eluent front 8 cm from the place where the samples were applied to the plate (18), the supply of the eluent components is stopped, then the plate (18) is removed from the chromatographic chamber (3) and dried under the hood. As a result, the chromatogram depicted in FIG. 6 was obtained.

FIG. 7 shows a schematic diagram of the first alternative system for delivering the eluent. This arrangement is presented with the omission of the control unit, which is as shown in FIG. 1. Inside the chromatographic chamber (35), there is a plate (36) in a horizontal position directed with the adsorbent layer upwards. Above it, there is a rigid tube (37) connected to the collector (38), with three identical supply lines connected to the collector (38) (39a, 39b, 39c). The first supply line (39a) consists of the first reservoir (40a) connected to the first pump (41a), to the outlet of which the first end of the flexible tube (42a) is connected, which in turn the second end is connected to the collector (38). The collector (38) is attached to the three-dimensional machine (43).

The three-dimensional machine (43) contains a body (44) to which the first lead screw (45) is mounted together with the support (46) on it and with transversely located carriage (47) driven by the second lead screw (48). The first lead screw (45) is driven by the first electric motor (49), and the second lead screw (48) is driven by the second electric motor not shown in the drawing.

The three-dimensional machine (43) enables the movement of the collector (38) with the rigid tube (37) along the path of a straight line (50) lying in the plane of the drawing from the first turning point (51) to the second turning point (52) and along the paths of any shapes over the plate (36), in a rectangular coordinate system.

### Example II

The method according to the invention has been used to develop the isocratic chromatogram according to the arrangement shown in FIG. 7. A HPTLC plate (36) from Merck with dimensions of 5×10 cm has an adsorbent in the form of silica gel. Flexible tubes (42a, 42b, 42c) of 1.6 mm external diameter and 0.2 mm internal diameter are made of Teflon, whose end parts are connected to a collector (38) of negligible capacity. The rigid tube (37) is made of a 50 mm long stainless steel tube of 1.6 mm outer diameter and 0.2 mm internal diameter. The outlet of the rigid tube (37) moves over the adsorbent layer of the plate (36). A specific composition of the solution supplied to the adsorbent layer is obtained through the appropriate speed of delivery of the individual eluent components from the supply lines (39a, 39b, 39c), toluene, ethyl acetate and methanol, respectively. In a particular case, the function of the rigid tube (37) may be filled by the outlet hole in the collector wall (38).

On the start line, 1 cm from the edge of the plate (36) and parallel to it, the solutions in the count of 9 were applied, mixtures of three dyes (3 places of application on the starting line) and solutions of individual dyes (6 places—2 places for each dye: orange, yellow and blue) using the Linomat 5 aerosol applicator from Camag. Next, an eluent was supplied to the adsorbent layer, which was pure toluene from the first supply line (39a). The distance of the end of the rigid tube (37) from the adsorbent layer was 0.2 mm and the length of the moving path was greater than the width of the plate (36) and was between the first turning point (51) and the second turning point (52). This line ran between the starting line and the closer to it parallel edge of the plate (36). The travel speed of the tip of the rigid tube (37) above the plate (36) was constant in both directions and was 30 mm/s, the speed of toluene delivery to the adsorbent layer during the chromatogram development process was also constant and was 5 mL/h. Through the other two supply lines (39b, 39c), in this experiment, the pumps did not pump solvents. Once the eluent front has traveled the distance of 4.0 cm from the starting line the solvent supply was stopped. The duration of this process was 10 minutes. The chromatographic plate was then dried and photographed. The image of the chromatogram obtained is shown in FIG. 8.

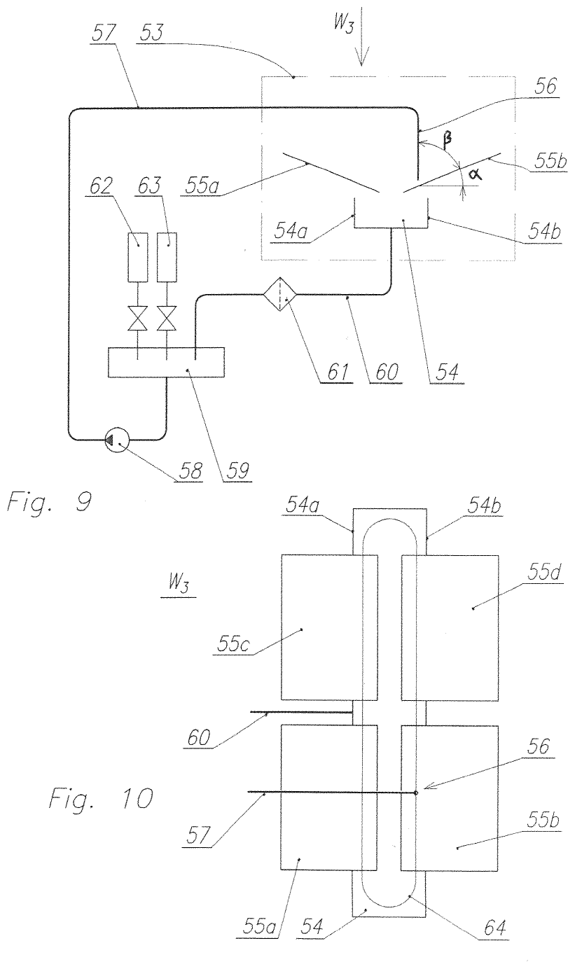

FIG. 9 is a schematic diagram of the second alternative system for delivering the eluent. In the chamber (53) there is a gutter (54) above which the plates (55a, 55b) are placed at an angle a relative to the level and directed with the adsorbent layer upwards, with the first plate (55a) being above the first side (54a) of the gutter (54), and the second plate (55b) being above the other side (54b). However, over the second plate (55b) there is a rigid tube (56) connected via a flexible tube (57) and a pump (58) to the reservoir (59). The rigid tube (56) can also move over the first plate (55a) thanks to the three-dimensional machine, not shown in the drawing, to which it is attached, constructed like the three-dimensional machine (43) shown in FIG. 7. The stream axis flowing out of the rigid tube (59) intersects the second plate (55b) at a sharp angle β. The reservoir (59), on the other hand, is connected to the gutter (54) via the drain line (60) on which the filter (61) is mounted. Two dispensers (62, 63) are also connected to the reservoir (59).

In order to supply the eluent to the adsorbent layer, the eluent is pumped through the pump (58) to the rigid tube (56) in the amount exceeding its absorption capability by the adsorbent layer, and the excess flows by gravity into the gutter (54), and then further through the filter (61) to the reservoir (59), where from the dispensers (62, 63) the quantity and composition of the eluent is replenished to the initial parameters, and then the regained eluent is further supplied to the adsorbent layer.

FIG. 10 shows the top view of the interior of the chamber of the second, alternative arrangement from the direction W₃ indicated in FIG. 9. Plates are arranged along the gutter (54). The first series of plates (55a, 55c) is arranged above the first side (54a), and the second series of plates (55b, 55d) is arranged above the second side (54b). Over the second plate there is a rigid tube (56) which, by the not shown three-dimensional machine, is moved over both rows of plates, along the path in the shape of a closed line (64) at a speed of 200 mm/s.

### Example III

The method of the invention has been used to prepare samples for instrumental analysis. In the first stage, nine standard solutions of paracetamol and acetanilide with the volume of 20 μL are applied with a microsyringe onto a chromatographic plate (65), 10 ×20 cm HPTLC from Merck with a layer of silica gel that is directed upwards along the starting line (66), spaced 1 cm from the long edge (67) of the plate (65). The concentration of acetanilide in these solutions was constant, whereas the concentration of paracetamol was varying. In addition, 20 μL of the test solution containing an unknown amount of paracetamol and the known acetanilide is applied in each of the further three locations on the start line. FIG. 11 shows the plate (65) with the nine standard solutions and the three test samples applied this way, which were marked 1-9 and X1-X3, respectively.

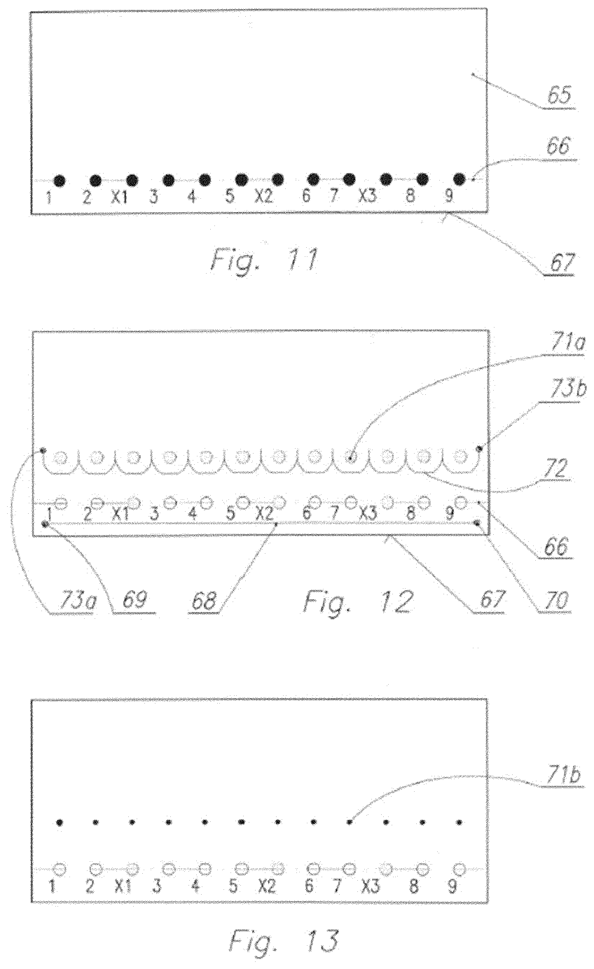

FIG. 12 shows the next two stages of the chromatogram development. Once the spots containing solutions of the substances applied to the start line (66) have dried, an isocratic chromatogram will be developed utilizing the apparatus shown in FIG. 7 with the use of the third supply line (39c) filled with methanol. In the first stage, methanol is supplied to the adsorbent layer with a capacity of 5 mL/h, at a moving speed of the rigid tube (37) equal to 50 mm/s at a distance of 0.1 mm above the adsorbent layer between the starting line (66) and the closer to its longer edge (67) of the plate (65) over the distance of 196 mm. This movement is repeatedly carried over along the straight line path (68) from the first turning point (69) to the second turning point (70) and back. Methanol is delivered until the eluent front reaches a distance of 30 mm from the starting line (66), after which the plate (65) is dried. During the delivery of the eluent, the target substance (paracetamol) and the internal standard (acetanilide) migrated practically with its front in the form of spots (71a).

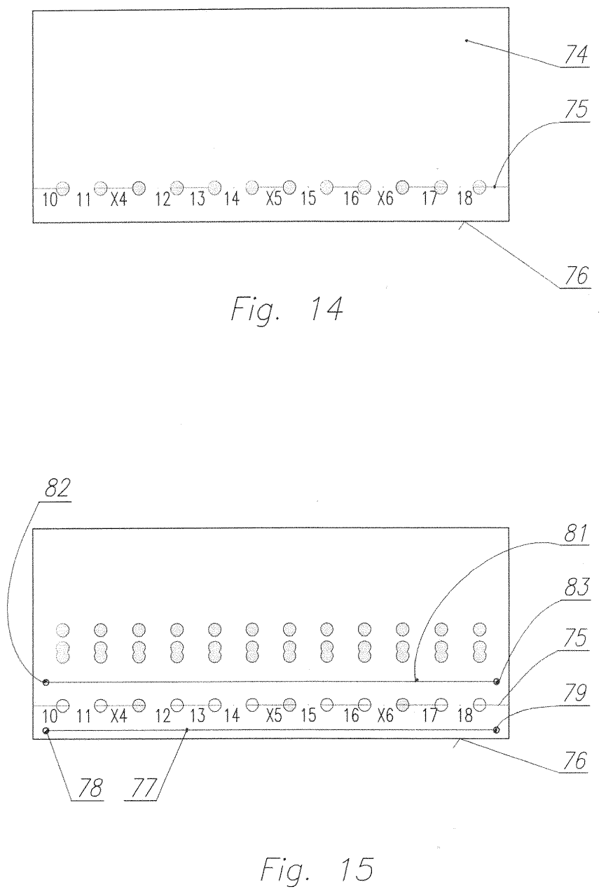

In the second step, the plate (65) is again subjected to methanol delivery to the adsorbent layer to obtain concentrated and narrowed substance zones (paracetamol and acetanilide). The methanol is supplied along a broken line path (72), from the first turning point (73) to the second turning point (74) and surrounding each of the spots (71a) on three sides. The broken line (72) consists of many straight sections and arcs. The methanol is supplied to the adsorbent layer with an efficiency of 2.5 mL/h at a rate of movement of the rigid tube (37) equal to 20 mm/s. Periodic movement of the rigid tube (37) over the adsorbent layer is interrupted when the adsorbent layer is completely wetted in the area of this road. FIG. 13 shows the concentration effect. The spots (71a) were significantly reduced and concentrated to the points (71b). After evaporation of the solvent (methanol), the adsorbent layer at the location of the respective paracetamol and acetanilide zones is scraped and transferred to separate vessels to which known amounts of methanol are added. The obtained suspensions are filtered, and the obtained solutions are subjected to the determination of paracetamol by the well-known method of the internal standard, using a high-performance liquid chromatograph with a UV detector.

### Example IV

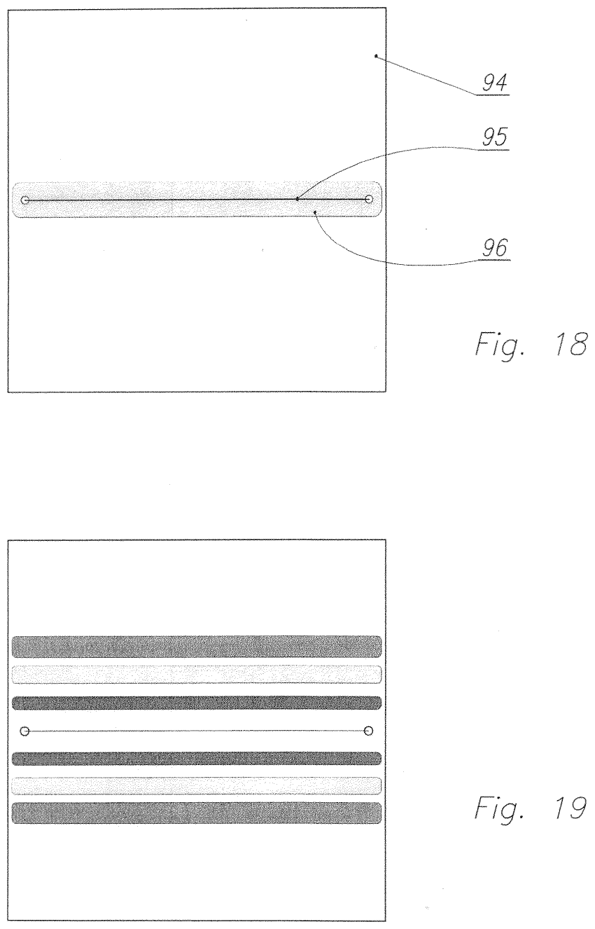

The preparation of a sample for instrumental analysis is shown in the steps in FIGS. 14-17. In a preliminary step, nine standard solutions containing known concentrations of three substances (acetylsalicylic acid, caffeine and paracetamol) of 20 μL, are applied with a microsyringe onto a 10×20 cm HPTLC RP-18W plate from Merck with a silanized silica gel layer that is along the start line (75), spaced 10 mm from the long edge (76) of the plate (74). The concentration of caffeine in these solutions was constant, while the concentration of acetylsalicylic acid and paracetamol had different values. Then, in three places on the start line (75), 20 μL of the test serum solution containing an unknown amount of acetylsalicylic acid and paracetamol and a known amount of caffeine are applied. FIG. 14 shows the application sites of the nine standard solutions and the three solutions of tested serum, which were marked 10-18 and X4-X6, respectively. The prepared plate (74) is dried.

Simultaneously, the arrangement shown in FIG. 7 is prepared for developing the isocratic chromatogram, in which the first line (39a) is filled with acetonitrile, the second line is filled with a buffer containing: a solution of 0.2 M sodium monophosphate (V) and 0.1 M solution of citric acid, pH 3.2, and the third line (39c) is filled with methanol. The plate (74) is placed in the chamber (35).

Then, in the second step, from the first line (39a) and the second line (39b), the eluent components are delivered to the adsorbent layer. Both lines (39a, 39b) supply solutions with different yields so that the eluent has a composition of 25% acetonitrile and 75% buffer. The total efficiency of the mobile phase delivery to the adsorbent layer was 5 mL/h. The third line (39c) was not used at this stage of the experiment.

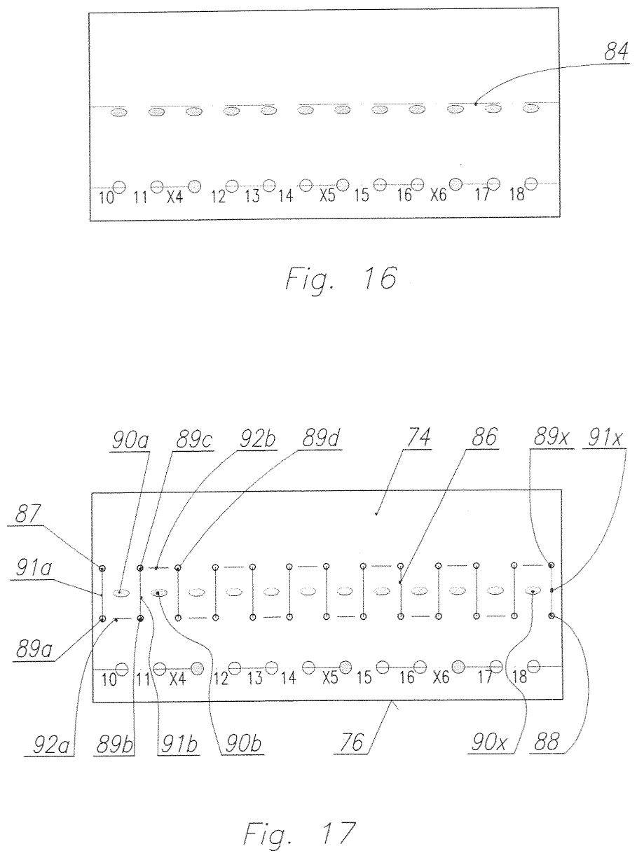

FIG. 15 shows the first and the second stage of chromatogram development. The end of the rigid tube (37) moves repeatedly over the adsorbent layer between the starting line (75) and the longer edge (76) along the first path (77) in a straight line from the first turning point (78) to the second turning point (79) and back again. The migration speed of the rigid tube (37) was 20 mm/s, and the distance of its tip from the outer surface of the adsorbent was 0.1 mm.

The development of the chromatogram was stopped when the eluent front reached the distance of 60 mm from the starting line (75). Under these conditions, the substances of interest: salicylic acid and paracetamol, and the internal standard: caffeine, showed values of the retardation coefficient, RF, 0.35, 0.48, 0.30, respectively. In this state, the plate (74) is dried, and then the second step is administered.

The first line (39a) and the second line (39b) are turned off, while from the third line (39c) methanol is delivered into the adsorbent layer with the efficiency of 5 mL/h and the travel speed of the tip of the rigid tube (37) equal to 20 mm s at a distance of 0, 1 mm from the adsorbent layer along the second path (81) in a straight line from the first turning point (82) to the second turning point (83) and back. The second path (81) is 20 mm away from the long edge (76). After reaching a 25 mm front migration distance (84) of methanol, measured from the second path (81), the methanol supply is stopped and the plate (74) is dried. FIG. 16 shows the effect of the second stage of the chromatogram development.

In the third step, shown in FIG. 7, a rigid tube (37) is led along the third path in the shape of a broken line (86) from the first turning point (87) to the second turning point (88) via intermediate points (89a, 89b, 89c, 89d . . . 89x) and back to the first turning point (87) skipping the intermediate points (89a, 89b, 89c, 89d . . . 89x). The third path (86) surrounds the subsequent spots interchangeably from three sides (90a, 90b 90x). Methanol, on the other hand, only runs on the vertical sections (91a, 91b . . . ) of the third path (86), breaking its pumping during the passage of the rigid tube (37) over the horizontal sections (92a, 92b . . . ) parallel to the long edge (76) and in time of return. The methanol supply is stopped when the adsorbent layer between the vertical sections (91a, 91b, . . . ) is completely wetted.

The third step can also be carried out according to a variant in which methanol is delivered along the vertical segment (91a) back and forth until the solvent front reaches the center of the spot (90a), and then the rigid tube (37) moves to the second vertical section (91b) and methanol is delivered until the first emerging front reaches the center of the first spot (90a) and the second front reaches the center of the second spot (90b) and so on until the adsorbent is wetted between the vertical sections (91a, 91b, . . . ) of all spots (90a, 90b . . . 90x). As a result of the implementation of the third stage the substance zones (acetylsalicylic acid, caffeine and paracetamol) were significantly reduced and concentrated.

The substances found in the concentrated zones were extracted with methanol in the usual manner using the Camag's TLC-MS Interface device connected to a liquid chromatography pump. This resulted in 12 solutions, corresponding to nine standard solutions and three tested, which were previously applied to the start line. The obtained solutions were subjected to the determination of acetylsalicylic acid and paracetamol by a known method in which caffeine was an internal standard, using a high performance liquid chromatograph with a UV detector and mass spectrometer.

### Example V

The method of the invention has also been used for preparative separation of substances mixture with the use of the system shown in FIG. 7. For this purpose, the first supply line (39a) is filled with a toluene solution of three dyes: 1-aminoanthraquinone, 2-nitroaniline and the fat green. The second supply line (39b) is filled with toluene, which acts as the eluent here, and the third supply line (39c) is not used. Then a plate (94) with dimensions of 200×200 mm with a layer of 0.5 mm thick silica gel is placed in the chromatographic chamber. Further, from the first supply line (39a), a dye solution is pumped along the start line (95) constituting the plate axis (94), until a band (96) of dyes to be separated with a width of 10 mm is obtained. At this point, the supply of the dye solution is stopped and the delivery of the eluent is started via the second supply line (39b) along the path that coincides with the starting line (95). This condition is shown in FIG. 18.

During this process, the eluent wetted the adsorbent layer simultaneously in two opposite directions—from the start line (95) to the opposite edges of the plate (94). When the eluent front reached both opposite edges of the chromatographic plate, the toluene supply was stopped, and the adsorbent layer was dried from the solvent. FIG. 19 shows the preparative chromatogram obtained in this example with bands of separated dyes. Next, the zones of the adsorbent layer in which the bands of separated substances were located were mechanically transferred to appropriate filters placed in three glass funnels and extracted with methanol. The extracts were collected in separate three vessels. In this way, separate methanol solutions of each dye were obtained. The evaporation of methanol yielded pure dyes.

What is claimed is:

1. A method of liquid delivery to an adsorbent layer of a chromatographic plate, in which method a liquid stream is directed to an outer surface of the adsorbent layer, characterized in that the liquid stream is composed of at least two individual streams (26a . . . 26x), differing in quantitative and/or qualitative composition of their components, which flow in separate tubes (8a, 9a, 9b, 9c . . . 9x, 42a, 42b, 42c), which tubes in the final part of their length are connected close to each other to allow combination of the individual streams (26a . . . 26x) that emerge from the tips of the tubes (9a . . . 9x, 42a, 42b, 42c), and the individual streams combine in the space between the tips of the tubes (9a . . . 9x, 42a, 42b, 42c) and the outer surface (28) of the adsorbent layer (24), then the combined individual streams are a collective liquid stream (32), which, using a coordinate machine (2, 43), moves repeatedly together with the tips of the tubes (9a, 9b, 9c . . . 9x, 37, 42a, 42b, 42c) along a given path over and on the outer surface (28) of the adsorbent layer (24), preferably the individual streams (26a . . . 26x) are pure solvents or a solution (mixture) of these solvents and/or solution of solid and/or liquid and/or gaseous substances in one and/or various solvents, preferably the proportion of individual streams of liquid supplied to the adsorbent layer changes continuously or gradually/in steps during the development of the chromatogram and is changed depending on the migration distance of the front of the liquid/solution developing the chromatogram or depending on the time of the chromatogram development process identical to the time of liquid delivery to the adsorbent layer.

2. The method according to claim 1, wherein the collective liquid stream (32) moves along a path in the form of a straight line (50, 68, 77, 81), many straight lines, broken line (72, 86), many broken lines, open or closed curved line (64), many separate open and/or closed curved lines (91a, 91b . . . 91x).

3. The method according to claim 1, wherein the collective liquid stream (32) moves at a given speed and along a given path, from a first turning point (21, 51) to a second turning point (22, 52) and back, where the first turning point (21) and the second turning point (22) lie below or above the outer surface of the adsorbent layer or the first turning point (51) and the second turning point (52) lie outside the outline of the adsorbent layer, preferably the travel speed from the first turning point (21, 51) to the second turning point (22, 52) differs from the travel speed from the second turning point (22, 52) to the first turning point (21, 51), even more preferably the travel speed from the first turning point (21) to the second turning point (22) is lower than the travel speed from the second turning point (22) to the first turning point (21).

4. The method according to claim 1, wherein the collective liquid stream (32) is successively moved over the surface of at least two separate layers of adsorbents (55a, 55b, 55c, 55d).

5. The method according to claim 1, wherein the delivery rate of the collective liquid stream supplied to the adsorbent layer is equal to or lower than the liquid absorption rate of the adsorbent layer, or the collective liquid stream delivery rate is greater than the liquid absorption rate of the adsorbent layer, in which case preferably the excess liquid is collected by gravity and accumulates in a gutter (54), then optionally solid impurities are separated and missing components are replenished, and then again delivered to the adsorbent layer.

6. The method according to claim 1, wherein the liquid stream is the collective liquid stream (32) and wherein the individual streams (26a . . . 26x) are pumped separately, and then they are combined directly in front of or on the outer surface (28) of the adsorbent layer (24), preferably each individual stream (26a . . . 26x) is pumped through the separate tube (8a, 9a, 9b, 9c . . . 9x, 42a, 42b, 42c) with a rate ranging from zero to the absorption rate of the solvent/liquid by the adsorbent layer (24), provided that the total pumping/delivery rate of all individual streams (26a . . . 26x) is lower than or equal to the rate of liquid absorption by the adsorbent layer (24).

7. The method according to claim 1, wherein the liquid stream is the collective liquid stream (32) and wherein each individual liquid stream (26a . . . 26x) is pumped with a separate, flexible tube (42a, 42b, 42c) to a collector (38), in which they are combined, and then the eluent thus obtained is supplied by a common rigid tube (37) on the outer surface of the adsorbent layer, preferably the rigid tube (37) is in the form of an opening in the collector wall (38).

8. The method according to claim 1, wherein the collective liquid stream (32) is stimulated to transverse and/or longitudinal vibrations relative to the given path.

9. The method according to claim 1, wherein the axis (33) of the collective liquid stream (32) is perpendicular to the outer surface (28) of the adsorbent layer (24) or the collective liquid stream (32) axis intersects the outer surface of the adsorbent layer at an acute angle.

10. A device for supplying liquids to the adsorbent layer (24) of a chromatographic plate (18), comprising:
a hydraulic unit (1) connected to a coordinate machine (2, 43), a chromatographic chamber (3) and a control unit (4) characterized in that the hydraulic unit (1) has at least two supply lines (5a, 5b, 5c . . . 5x, 39a, 39b, 39c), comprising reservoirs (6a, 6b, 6c . . . 6x, 40a), pumps (7a, 7b, 7c . . . 7x, 41a) and tubes (8a, 9a . . . 9x, 37, 42a, 42b, 42c), where the tubes (8a, 9a, 9b, 9c . . . 9x, 42a, 42b, 42c) of several supply lines in the final part of their length are connected close to each other so as to allow combination of the liquid streams emerging from the tubes,
wherein the connected tubes in their final length are attached together to the coordinate machine (2, 43) to enable movement in three dimensions, such that the tips of these can be moved together at a short distance from the outer surface (28) of the adsorbent layer (24) and along a given path on the adsorbent layer (24) of the chromatographic plate.

11. The device for delivering liquid to the adsorbent layer according to claim 10, wherein the hydraulic unit (1) contains supply lines (39a, 39b, 39c) equipped with conduits/tubes (42a, 42b, 42c) at one end connected to pumps (41a) for dosing/delivering liquids, where at the other end the conduits/tubes are connected to a collector (38), which is equipped with an opening, preferably of 0.05 to 1.0 mm diameter, wherein the collector (38) is attached to the coordinate machine (43) which enables movement of the collector (38) such that the opening of the collector can be arranged at a short distance from the adsorbent layer of the chromatographic plate and wherein the movement can be along a given path in the form of a straight line, many straight lines, broken line, many broken lines, open or closed curved line, many open or closed curved lines, alternatively, instead of the mentioned opening, the collector (38) is equipped with a rigid tube (37), preferably of length up to 50 mm, wherein the collector (38) is attached to the coordinate machine (43) and wherein due to drive of the coordinate machine, the collector (38) and the outlet of the rigid tube (37) can be moved along a given path as above at a short distance from the outer surface (28) of the adsorbent layer (24) of the chromatographic plate.

12. The device according to claim 11, wherein the hydraulic assembly (1) has at least two supply lines (5a, 5b, 5c . . . 5x), comprising the reservoirs (6a, 6b, 6c . . . 6x), pumps (7a, 7b, 7c . . . 7x) and tubes (8a), where the tubes of several supply lines are connected in the final part of their length into a bundle (10), and the bundle (10) is attached to the coordinate machine (2, 43), such that the tip (11) of the bundle (10) can be moved at a short distance from the outer surface (28) of the adsorbent layer (24) and along a given path on the adsorbent layer (24) of the chromatographic plate.

13. The device according to claim 12, wherein the tip (11) consists of at least two adjacent rigid tubes (9a, 9b, 9c, . . . 9x), preferably clipped together with a band, from which rigid tubes (9a, 9b, 9c . . . 9x) the individual streams flow out (26a, 26b, 26c . . . 26x).

14. The device according to claim 13, wherein the tip (11) is additionally equipped with a nozzle (30) comprising an outlet opening (31), wherein the individual streams (26a, 26b, 26c . . . 26x) combine inside of the nozzle (30), forming a collective stream (32) that flows out through the outlet opening (31), preferably the nozzle (30) is in the form of a rotary block, and the outlet opening is placed in its axis (33).

15. The device, according to claim 11, wherein the tip (11) or the collector (38) adheres to a working segment of a vibrator (13).
